(19) United States
(12) Patent Application Publication
(10) Pub. No.: US 2008/0102410 A1
(43) Pub. Date: May 1, 2008

(54) Method of manufacturing printed circuit board

(75) Inventors: Ji-Eun Kim, Gwangmyeong-si (KR); Myung-Sam Kang, Suwon-si (KR); Jung-Hyun Park, Suwon-si (KR); Hoe-Ku Jung, Daedeok-gu (KR); Jong-Gyu Choi, Seoul (KR); Jeong-Woo Park, Suwon-si (KR); Sang-Duck Kim, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/976,211

(22) Filed: Oct. 22, 2007

(30) Foreign Application Priority Data
Oct. 27, 2006 (KR) 10-2006-0104893

(51) Int. Cl. G03C 5/00

(52) U.S. Cl. 430/312

(57) ABSTRACT

A method of manufacturing a printed circuit board is disclosed, in which a cavity is formed for embedding a component, which includes: providing a core board, in which an inner circuit is buried; forming a first via in the core board for interlayer conduction; selectively forming a first photoresist in a position on the core board in correspondence with a position of the cavity; stacking a first build-up layer, on which a first outer circuit is formed, on the core board; and selectively removing the first build-up layer in correspondence with the position of the cavity and removing the first photoresist. Utilizing the method, a board can be manufactured with greater precision, as the thickness tolerance of the cavity may be obtained by controlling the thickness of the photoresist, and the overall thickness of the board can be controlled by controlling the height of the cavity.

### CROSS-REFERENCE TO RELATED APPLICATIONS

This application claims the benefit of Korean Patent Application No. 10-2006-0104893 filed with the Korean Intellectual Property Office on Oct. 27, 2006, the disclosure of which is incorporated herein by reference in its entirety.

### BACKGROUND

1. Technical Field

The present invention relates to a method of manufacturing a printed circuit board.

2. Description of the Related Art

With advances in the electronics industry, there is a growing demand for smaller electronic products having greater functionality, and in particular, there is a need to decrease the thicknesses of the various parts equipped in a mobile terminal, to reduce its overall thickness. Also, with the number of services provided rapidly increasing in the field of mobile communication, various electronic components are being installed in the mobile terminal, such as a cell phone, etc.

Accordingly, in response to these trends towards greater functionality and smaller sizes, the mainstream was to use the so-called “IC-stacked” products, in which several components are stacked in one package. Recently, “package-stacked” products have also been produced, in which several package boards having one or more embedded components are stacked together.

In the case of a component-embedded printed circuit board according to the related art, an IC is embedded in the surface of a core board, and vias are formed that connect with the electrodes (Cu bumps) of the IC, in order to electrically connect the IC and the circuit pattern of the board. However, such related art lacks precision in processing the cavity, which is a space in which to embed the IC, and allowing for tolerances in the thickness of the cavity may lead to increased overall thickness of the printed circuit board.

### SUMMARY

An aspect of the invention is to provide a method of manufacturing a printed circuit board, in which the board thickness may be decreased with a high degree of precision, by reserving the cavity space using photoresist during the process of manufacturing a multi-layered printed circuit board employing buried patterns.

One aspect of the invention provides a method of manufacturing a printed circuit board, in which a cavity is formed for embedding a component. The method includes: providing a core board, in which an inner circuit is buried; forming a first via in the core board for interlayer conduction; selectively forming a first photoresist in a position on the core board in correspondence with a position of the cavity; stacking a first build-up layer, on which a first outer circuit is formed, on the core board; and selectively removing the first build-up layer in correspondence with the position of the cavity and removing the first photoresist.

After removing the first build-up layer and the first photoresist, an operation of forming a bonding pad on the core board may additionally be performed, where the bonding pad electrically connects the component and the inner circuit. Forming the bonding pad may be achieved by performing gold plating selectively on a surface of the inner circuit.

Preparing the core board may include stacking a seed layer on a carrier; forming an intaglio pattern, which corresponds with the inner circuit, in the seed layer; and filling a conductive material in the intaglio pattern. Here, forming the intaglio pattern may include stacking a photosensitive film on the seed layer and forming a second photoresist as a relievo pattern corresponding with the intaglio pattern by selectively performing exposure and development on the photosensitive film.

Furthermore, the method may further include, after forming the second photoresist, removing the second photoresist and transcribing a conductive material filled in the intaglio pattern into an insulation board by pressing the seed layer onto the insulation board.

Forming the first via may be performed by processing a via hole in the core board, performing electroless plating on an inner wall of the via hole and on one side of the core board on which the first photoresist is formed, and performing electroplating in the via hole.

Also, after selectively forming the first photoresist, an operation of performing flash etching on the core board may additionally be included, and an operation of removing an electroless-plated layer interposed between the first photoresist and the core board may further be included afterwards.

Selectively forming the first photoresist may include stacking a photosensitive film on the core board and selectively performing exposure and development on the photosensitive film, while the method may further include, after stacking the first build-up layer forming a second via in the first build-up layer such that the inner circuit and the first outer circuit are electrically connected.

Removing the first build-up layer and the first photoresist may be performed by exposing the first photoresist, by processing the first build-up layer to correspond with a position of the cavity, and removing the first photoresist.

In addition, after removing the first build-up layer and the first photoresist, the method may further include embedding a component in the cavity and stacking a second build-up layer, on which a second outer circuit is formed, on the first build-up layer.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a flowchart illustrating a method of manufacturing a printed circuit board according to an embodiment of the present invention.

FIG. 2 is a cross-sectional view of printed circuit board manufactured according to an embodiment of the present invention.

FIG. 3A and FIG. 3B represent a flow diagram illustrating a process in manufacturing a printed circuit board according to an embodiment of the present invention.

FIG. 4A, FIG. 4B, and FIG. 4C represent a flow diagram illustrating a process in manufacturing a printed circuit board according to an embodiment of the present invention.

FIG. 5A and FIG. 5B represent a flow diagram illustrating a process in manufacturing a printed circuit board according to an embodiment of the present invention.

FIG. 6A, FIG. 6B, FIG. 6C, FIG. 6D, and FIG. 6E represent a flow diagram illustrating a process in manufacturing a printed circuit board according to an embodiment of the present invention.

FIG. 7A, FIG. 7B, and FIG. 7C represent a flow diagram illustrating a process in manufacturing a printed circuit board according to an embodiment of the present invention.

FIG. 8 is a cross-sectional view illustrating a component embedded in the printed circuit board of FIG. 2.

### DETAILED DESCRIPTION

The method of manufacturing a printed circuit board according to certain embodiments of the invention will be described below in more detail with reference to the accompanying drawings, in which those components are rendered the same reference numeral that are the same or are in correspondence, regardless of the figure number, and redundant explanations are omitted.

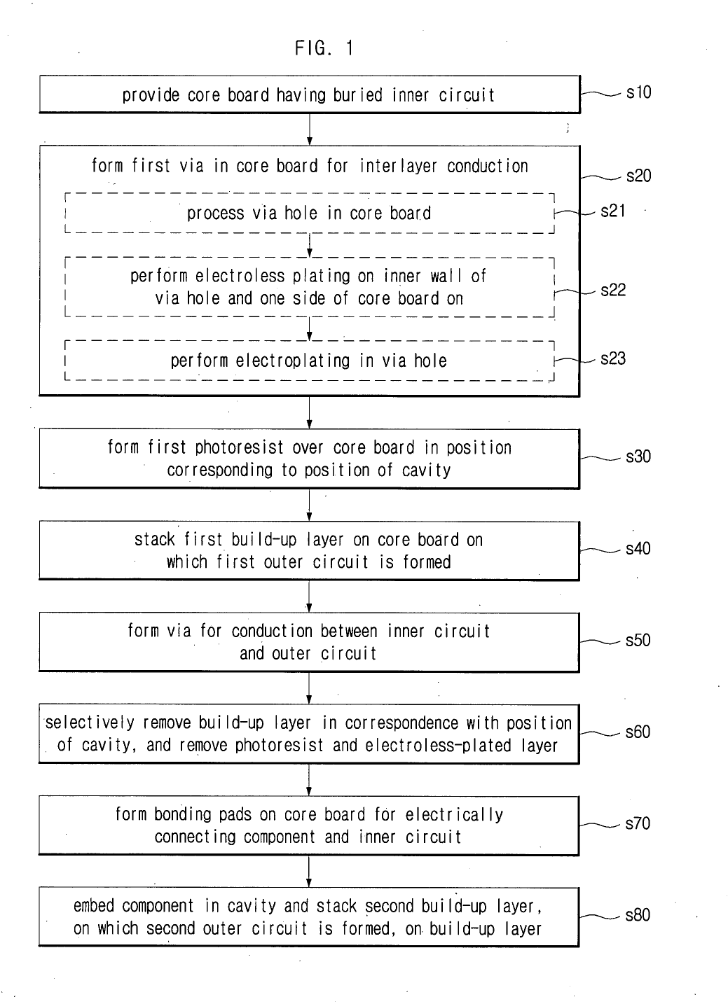

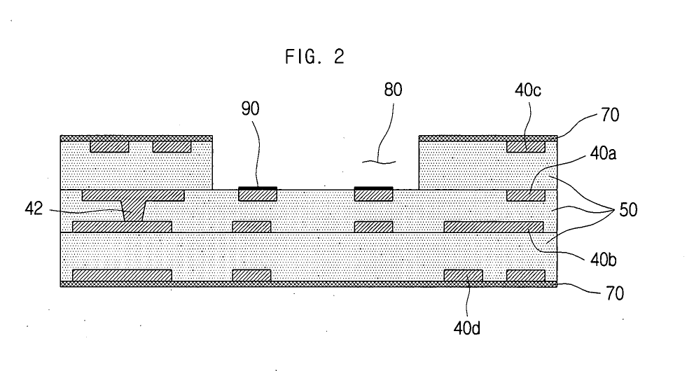

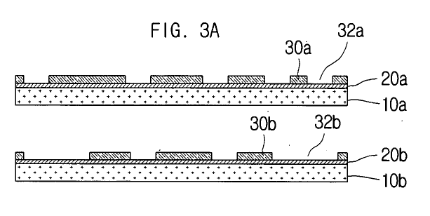

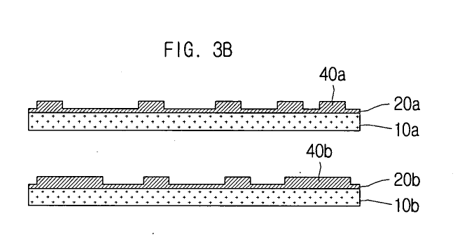

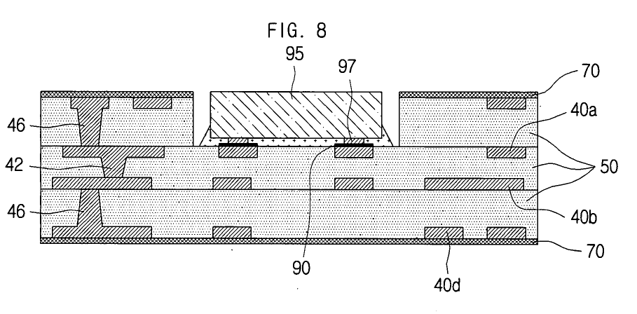

FIG. 1 is a flowchart illustrating a method of manufacturing a printed circuit board according to an embodiment of the present invention, and FIG. 2 is a cross-sectional view of printed circuit board manufactured according to an embodiment of the present invention, while FIGS. 3A and 3B, FIGS. 4A to 4C, FIGS. 5A and 5B, FIGS. 6A to 6E, and FIGS. 7A to 7C represent a flow diagram illustrating a process in manufacturing a printed circuit board according to an embodiment of the present invention. FIG. 8 is a cross-sectional view illustrating a component embedded in the printed circuit board of FIG. 2.

In the drawings are illustrated carriers 10a, 10b, seed layers 20a, 20b, photoresist 30a, 30b, 60, inner circuits 40a, 40b, vias 42, 46, insulation boards 50, solder resist 70, a cavity 80, bonding pads 90, a component 95, and electrodes 97.

Operation s10 is of providing a core board in which inner circuits 40a, 40b are buried. One method of forming a core board having buried inner circuits 40a, 40b will be described below in more detail.

First, seed layers 20a, 20b may be stacked on carriers 10a, 10b. The seed layers 20a, 20b may be made of a copper material, and may be stacked on the carriers 10a, 10b by performing electroless plating. Of course, the material and forming method of the seed layers 20a, 20b may vary.

Photosensitive films may be stacked onto the seed layers 20a, 20b, and then exposure and development processes may be performed. In this way, photoresist 30a, 30b may be formed on the seed layers 20a, 20b (see FIG. 3A), and using the photoresist 30a, 30b, intaglio patterns 32a, 32b may be formed that correspond with the inner circuits 40a, 40b.

Afterwards, conductive material may be filled in the intaglio patterns 32a, 32b. The conductive material may be filled in the intaglio patterns 32a, 32b by electroplating. In the case of using copper material for the seed layers 20a, 20b, copper may also be used for the conductive material.

While electroplating is presented in this embodiment as a method of filling conductive material in the intaglio patterns 32a, 32b, it is to be appreciated that this may be changed according to design requirements. The conductive material thus filled in the intaglio patterns 32a, 32b may later serve as inner circuits 40a, 40b.

After filling the intaglio patterns 32a, 32b with the conductive material, the photoresist 30a, 30b may be removed, to complete the preparations for transcribing the conductive material into an insulation board 50 (see FIG. 3B).

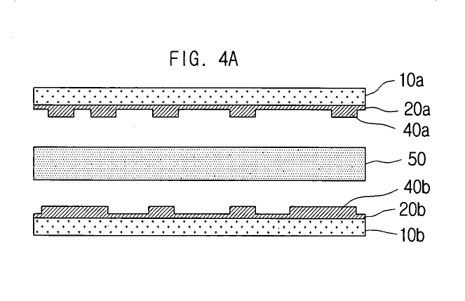

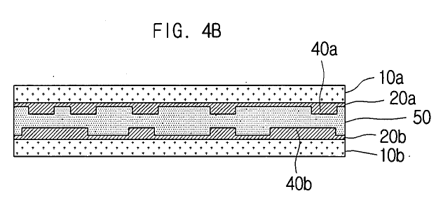

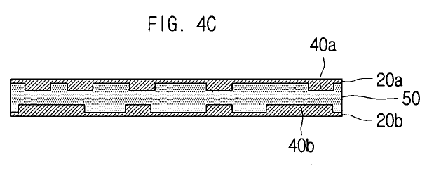

Next, after aligning the carriers 10a, 10b with the insulation board 50 positioned in-between, as in FIG. 4A, the carriers 10a, 10b and insulation board 50 may be compressed together, as illustrated in FIG. 4B. Such compression may result in the inner circuits 40a, 40b being buried in the insulation board 50.

Afterwards, in order to leave only the inner circuits 40a, 40b in the insulation board 50, the carriers 10a, 10b and seed layers 20a, 20b may be removed, as illustrated in FIG. 4C. If the seed layers 20a, 20b are formed from a copper material, as mentioned above, the seed layers 20a, 20b may be removed by etching.

Through the procedures described above, a core board may be provided in which inner circuits 40a, 40b are buried.

Operation s20 is of forming a via 42 in the core board for interlayer conduction. That is, the via 42 may be formed in order that the inner circuits 40a, 40b buried in either side of the core board may be electrically connected with each other. One process of forming the via 42 will be described below in more detail.

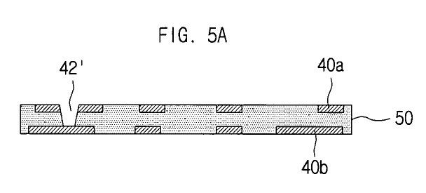

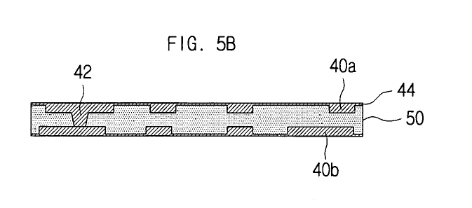

First, as illustrated in FIG. 5A, a via hole 42′ may be processed (operation s21). Processing the via hole 42′ may be performed by a method such as laser drilling, although various other methods may obviously be used.

Electroless plating may be performed on a side of the core board, including the inner wall of the processed via hole 42′ (s22). The electroless-plated layers 44, 44′ formed by electroless plating may serve as seed layers for filling the via hole 42′ with conductive material, and may also serve to provide tolerance while processing the cavity 80, which will be described later.

In order to fill the processed via hole 42′ with conductive material to form a via 42, electroplating may be performed in the via hole 42′ (operation s23). This process may be performed by forming photoresist (not shown), in which only the position corresponding with the via hole 42′ is opened selectively, over the core board, and then performing electroplating.

When the electroplating is complete, flash etching may be performed in order to level out the surface, and then the photoresist (not shown) may be removed. In this way, the via 42 may be formed on the core board, as illustrated in FIG. 5B.

Operation s30 is of forming photoresist 60 over the core board in a position corresponding with the position where the cavity 80 is to be formed. Forming the photoresist 60 may be performed by stacking a photosensitive film on the core board, selectively exposing portions of the photosensitive film corresponding with the position where the cavity 80 is to be formed, and then developing. Afterwards, flash etching may be performed again to level out the surface.

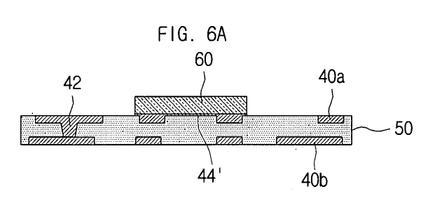

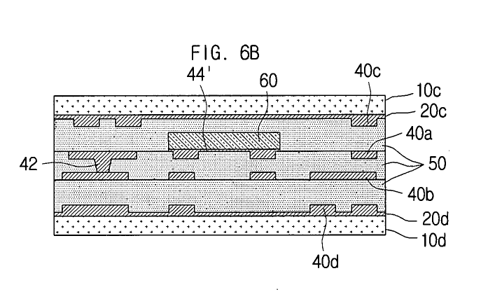

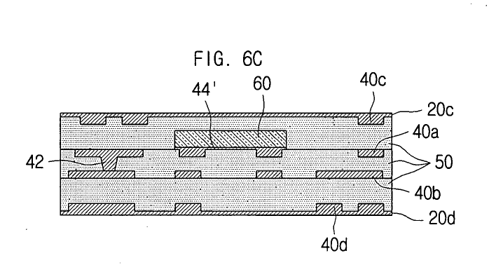

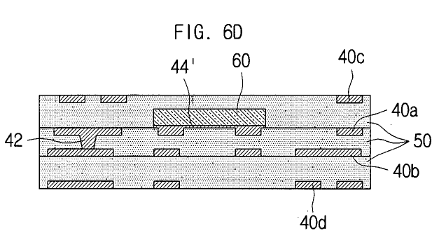

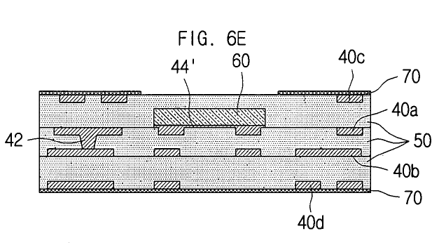

By these procedures, the photoresist 60 may be formed on the core board in a position corresponding to the position where the cavity 80 is to be formed, as illustrated in FIG. 6A, with a portion 44′ of the electroless-plated layer 44, implemented for forming the via 42, interposed between the photoresist 60 and the core board.

That is, due to the flash etching performed after forming the via 42, the areas of the electroless-plated layer that are not covered by the photoresist 60 are removed, while the areas of the electroless-plated layer 44′ that are covered by the photoresist 60 are not removed.

Operation s40 is of stacking build-up layers, in which outer circuits 40c, 40d are formed, on the core board. This may be to form a multilayer printed circuit board. Forming the build-up layers may be performed in accordance with the process for forming the core board described above.

In other words, a build-up layer may also be formed by a method of forming an intaglio pattern on a carrier in correspondence to an outer circuit 40c, 40d, filling a conductive material in the intaglio pattern, transcribing the conductive material formed in the intaglio pattern onto an insulation board (see FIG. 6B), removing the carrier 10c, 10d (see FIG. 6C), and afterwards removing the seed layer 20c, 20d (see FIG. 6D). As the specifics of this may be the same as or similar to the method of forming the core board, it will not be described in further detail.

Operation s50 is of forming vias 46 for conduction between the inner circuits 40a, 40b and the outer circuits 40c, 40d. The vias 46 may be formed in the build-up layers so that the inner circuits 40a, 40b and outer circuits 40c, 40d can exchange electrical signals. The vias 46 formed in the build-up layers may be formed by the same method as the method described above for forming the via 42 in the core board.

Although the procedures for forming the vias 46 are not illustrated in FIGS. 6A to 6E, these are the same as the procedures described above, and thus the following descriptions will refer to FIGS. 5A and 5B for better understanding.

Thus, a via hole (not shown) may first be processed by a method such as laser drilling, and electroless plating may be performed in the processed via hole (not shown), after which electroplating may be performed in the via hole (not shown), to form a build-up layer. After the completion of the electroplating, flash etching may be performed, as described above, for leveling out the surface.

After performing the flash etching, the seed layers (not shown) formed for the electroless plating may be removed, and then solder resist 70 may be applied, as illustrated in FIG. 6D, to protect the outer circuits 40c, 40d formed in the build-up layers. Here, the solder resist 70 may be applied in portions excluding the areas that are to be processed in operation s60 described below.

Operation s60 is of selectively removing the build-up layers in correspondence with the position of the cavity 80, and then removing the photoresist 60 and the electroless-plated layer 44′.

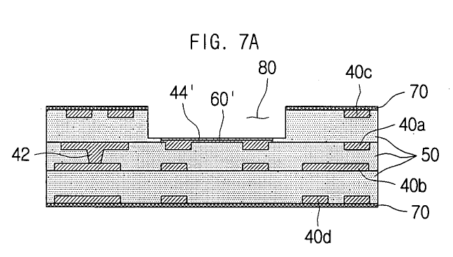

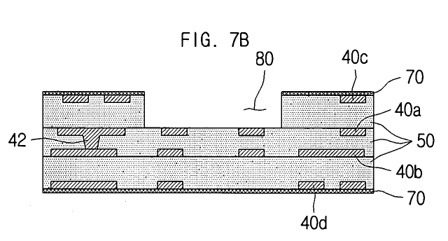

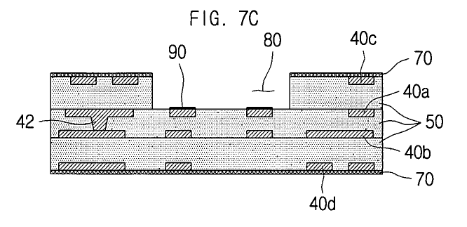

To be more specific, the build-up layer may be processed along the Z-axis in the position where the component 95 is to be embedded, to expose the photoresist 60 formed on the surface of the core board (see FIG. 7A), the exposed photoresist 60 may be peeled off and removed, and then the electroless-plated layer 44′ interposed between the photoresist 60 and the core board may be removed such that the core board is exposed (see FIG. 7B), whereby the cavity 80 may be formed.

In processing the build-up layer along the Z-axis to form the cavity 80, the photoresist 60 and electroless-plated layer 44′ allow for processing tolerance, so that a higher degree of precision may be obtained.

Operation s70 may include forming bonding pads 90 on the core board, in order to electrically connect the component 95 with the inner circuits 40a. This is to form the bonding pads 90 before bonding the component within the cavity 80.

The bonding pads 90, as illustrated in FIG. 7C, may be formed on predetermined positions on an inner circuit 40a, 40b buried in the core board, and may advantageously be made of a material of which the electrical conductivity is greater that that of the inner circuit 40a, 40b.

For example, if the inner circuit 40a, 40b is made of a copper material, the bonding pads 90 may be made of a gold material. Thus, the bonding pads 90 may be formed by performing electroplating using gold on predetermined positions on the inner circuits 40a, 40b.

Operation s80 may include embedding the component 95 in the cavity, and stacking a second build-up layer, on which a second outer circuit is formed, on the build-up layer. This may be to manufacture a multilayer printed circuit board having an embedded component 95, and by embedding the component 95 in the cavity, as illustrated in FIG. 8, a thin PoP (Package on Package) board may be manufactured.

The method of forming a second build-up layer (not shown) having a second outer circuit (not shown) may be the same as or similar to the method described above for forming the build-up layer or the core board, it will not be described here in further detail.

According to certain embodiments of the invention as set forth above, a board can be manufactured with greater precision, as the thickness tolerance of the cavity may be obtained by controlling the thickness of the photoresist, and the overall thickness of the board can be controlled by controlling the height of the cavity.

Also, as the outer circuits and core circuits may be formed by employing a buried-pattern method of burying the circuit patterns in insulation material, the board can be made with a smaller thickness and greater stiffness, with less warpage of the embedded component and less curves in the surface of the board, so that there may be greater levelness than in conventional boards.

Furthermore, as the component may be embedded in the surface of the core board, no additional carrier member may be needed in embedding the component.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A method of manufacturing a printed circuit board having a cavity formed therein for embedding a component, the method comprising:
providing a core board having an inner circuit buried therein;
forming a first via in the core board for interlayer conduction;
selectively forming a first photoresist in a position on the core board in correspondence with a position of the cavity;
stacking a first build-up layer on the core board, the first build-up layer having a first outer circuit formed thereon; and
selectively removing the first build-up layer in correspondence with the position of the cavity and removing the first photoresist.

2. The method of claim 1, further comprising, after removing the first build-up layer and the first photoresist:
forming a bonding pad on the core board, the bonding pad configured to electrically connect the component and the inner circuit.

3. The method of claim 2, wherein forming the bonding pad comprises:
performing gold plating selectively on a surface of the inner circuit.

4. The method of claim 1, wherein providing the core board comprises:
stacking a seed layer on a carrier;
forming an intaglio pattern in the seed layer, the intaglio pattern being in correspondence with the inner circuit; and
filling a conductive material in the intaglio pattern.

5. The method of claim 4, wherein forming the intaglio pattern comprises:
stacking a photosensitive film on the seed layer; and
forming a second photoresist as a relievo pattern corresponding with the intaglio pattern by selectively performing exposure and development on the photosensitive film.

6. The method of claim 5, further comprising, after forming the second photoresist:
removing the second photoresist; and
transcribing a conductive material filled in the intaglio pattern into an insulation board by pressing the seed layer onto the insulation board.

7. The method of claim 1, wherein forming the first via comprises:
processing a via hole in the core board;
performing electroless plating on an inner wall of the via hole and on one side of the core board having the first photoresist formed thereon; and
performing electroplating in the via hole.

8. The method of claim 7, further comprising, after selectively forming the first photoresist:
performing flash etching on the core board.

9. The method of claim 8, further comprising, after removing the first build-up layer and the first photoresist:
removing an electroless-plated layer interposed between the first photoresist and the core board.

10. The method of claim 1, wherein selectively forming the first photoresist comprises:
stacking a photosensitive film on the core board; and
selectively performing exposure and development on the photosensitive film.

11. The method of claim 1, further comprising, after stacking the first build-up layer:
forming a second via in the first build-up layer such that the inner circuit and the first outer circuit are electrically connected.

12. The method of claim 1, wherein removing the first build-up layer and the first photoresist comprises:
exposing the first photoresist by processing the first build-up layer to correspond with a position of the cavity; and
removing the first photoresist.

13. The method of claim 1, further comprising, after removing the first build-up layer and the first photoresist:
embedding a component in the cavity and stacking a second build-up layer on the first build-up layer, the second build-up layer having a second outer circuit formed thereon.
